(19) United States
(12) Patent Application Publication
(10) Pub. No.: US 2024/0220823 A1
(43) Pub. Date: Jul. 4, 2024

(54) MACHINE LEARNING INSIGHTS BASED ON IDENTIFIER DISTRIBUTIONS

(71) Applicant: Optum, Inc., Minnetonka, MN (US)

(72) Inventors: Wesley A. CAMP, Horsham, PA (US); Luke B. SLINDEE, Hopkins, MN (US); Michael C. NORTHINGTON, V, Aurora, CO (US)

(21) Appl. No.: 18/149,441

(22) Filed: Jan. 3, 2023

(51) Int. Cl. G06N 5/022

(52) U.S. Cl. CPC G06N 5/022

(57) ABSTRACT

Various embodiments of the present disclosure disclose a rules-based technique for automatically generating predictive insights using distributions of identifiers. The techniques include receiving a predictive identifier count data object for an entity based on a historical interaction dataset associated with a plurality of entities. The techniques include generating a distribution data object for the entity based on the first identifier count for the first predictive identifier and the second identifier count for the second predictive identifier. The techniques include generating, using a machine learning classification model, a predictive classification for the entity based on the distribution data object. The techniques include providing an indication of the predictive classification for the entity.

### BACKGROUND

Various embodiments of the present disclosure address technical challenges related to complex data processing techniques given limitations of existing predictive data analysis processes. Existing techniques for generating predictive classifications, for example, may be time consuming, resource intensive, and, in some cases, may not be automated. Automated techniques often rely on descriptive identifiers that may lack accuracy, offer limited scope, and/or are not readily accessible, which limits the efficiency and reliability of such techniques. Moreover, existing techniques, whether manually or automatically performed, are configured to generate predictive classifications that lack granularity, accuracy, and consistency. Such classifications may be misleading and are impractical for a number of post processing tasks such as identifying entity/classification trends or cross-entity relationships, fraud detection, and/or the like. Various embodiments of the present disclosure make important contributions to various existing predictive data analysis systems by addressing each of these technical challenges.

### BRIEF SUMMARY

Various embodiments of the present disclosure disclose techniques for orchestrating a complex data processing scheme for a classification process using a machine-learning classification model that is trained to generate predictive classifications for an entity based on identifier distributions. In some embodiments, the machine-learning classification model is trained to make accurate predictive classifications based on preprocessed input data associated with the identifier distributions. The input data, for example, may be processed according to specific rules-based techniques to automatically create predictive information from identifiers that may be non-descriptive. Such information may be embodied by one or more new data structures described herein. Using some of the techniques described herein, a proposed system may intelligently and automatically process complex, potentially non-descriptive data to generate accurate predictive classifications for entities that improve upon the accuracy, availability, and granularity of existing data processing techniques, while reducing time and processing resources consumed by such techniques.

In some embodiments, a computer-implemented method comprises receiving, by one or more processors, a predictive identifier count data object for an entity based on a historical interaction dataset associated with a plurality of entities, wherein the predictive identifier count data object is indicative of one or more identifier counts for one or more predictive identifiers associated with the entity; generating, by the one or more processors and using a machine learning classification model, a predictive classification for the entity based on the one or more identifier counts; and providing, by the one or more processors, an indication of the predictive classification for the entity.

In some embodiments, a computing apparatus comprising one or more processors and memory including program code is provided. The memory and the program code are configured to, when executed by the one or more processors, cause the one or more processors to: receive a predictive identifier count data object for an entity based on a historical interaction dataset associated with a plurality of entities, wherein the predictive identifier count data object is indicative of one or more identifier counts for one or more predictive identifiers associated with the entity; generate, using a machine learning classification model, a predictive classification for the entity based on the one or more identifier counts; and provide an indication of the predictive classification for the entity.

In some embodiments, a computer program product comprising a non-transitory computer-readable storage medium is provided. The computer-readable storage medium includes instructions that, when executed by one or more processors, cause the one or more processors to: receive a predictive identifier count data object for an entity based on a historical interaction dataset associated with a plurality of entities, wherein the predictive identifier count data object is indicative of one or more identifier counts for one or more predictive identifiers associated with the entity; generate, using a machine learning classification model, a predictive classification for the entity based on the one or more identifier counts; and provide an indication of the predictive classification for the entity.

### BRIEF DESCRIPTION OF THE DRAWINGS

FIG. 1 is a schematic diagram showing an example computing system for generating predictive insights using distributions of identifiers in accordance with one or more embodiments of the present disclosure.

FIG. 2 is a schematic diagram showing a system computing architecture in accordance with some embodiments discussed herein.

FIG. 3 is a flowchart showing an example of a process for generating predictive insights using distributions of identifiers in accordance with some embodiments discussed herein.

FIG. 4 provides a dataflow diagram showing example data structures for generating predictive insights using distributions of identifiers in accordance with some embodiments discussed herein.

FIG. 5 provides an operational example of a predictive identifier count data object in accordance with some embodiments discussed herein.

FIG. 6 is a flowchart showing an example of a process for generating a distribution data object in accordance with some embodiments discussed herein.

FIG. 7 provides an operational example of a predictive category data object in accordance with some embodiments discussed herein.

FIG. 8 provides an operational example of a type-specific distribution in accordance with some embodiments discussed herein.

FIG. 9 provides an operational example of a predictive classification data object in accordance with some embodiments discussed herein.

FIG. 10 is a flowchart showing an example of a process for verifying an assigned classification for an entity in accordance with some embodiments discussed herein.

FIG. 11 is a flowchart showing an example of a process for generating a peer entity data object in accordance with some embodiments discussed herein.

FIG. 12 provides an operational example of a peer entity data object in accordance with some embodiments discussed herein.

FIG. 13 is a flowchart showing an example of a process for investigating an entity in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout. Moreover, while certain embodiments of the present disclosure are described with reference to predictive data analysis, one of ordinary skill in the art will recognize that the disclosed concepts may be used to perform other types of data analysis.

### I. OVERVIEW, TECHNICAL IMPROVEMENTS, AND TECHNICAL ADVANTAGES

Embodiments of the present disclosure present new rules-based techniques that improve computer interpretation of identifiers (e.g., non-descriptive identifiers, and/or the like) enabling the automatic generation of predictive classifications. To do so, the present disclosure provides a multi-stage data processing scheme in which identifiers are extracted from historical interaction-based data objects for a number of different entities and then aggregated and modeled using new object data structures to generate predictive classifications for the entities. The new object data structures may each emphasize different predictive aspects of the potentially non-descriptive identifiers to improve the accuracy, granularity, and reliability of predictive classifications. A machine learning model may be trained to leverage the new object data structures to automatically generate predictive classifications that are more accurate, granular, and reliable than classifications assigned through conventional techniques. In this way, the present disclosure provides improved input data structures, machine learning models, and data processing techniques that improve upon conventional classification techniques.

More particularly, the multi-stage data processing scheme includes a number of data processing operations that aggregate and model a plurality of identifiers into a hierarchical set of data objects that incrementally enhance predictive aspects of the identifiers. The hierarchical set of data objects, for example, may include a count data object that is refined to generate a category count data object. The category count data object may be further refined to generate a distribution data object. The resulting distribution data object may be processed by a machine learning classification model to generate a predictive classification. By incrementally enhancing predictive aspects of potentially non-descriptive identifiers, the multi-stage data processing scheme improves upon conventional classification solutions that rely on brute force communications directly with entities which may be time consuming, resource intensive, and/or result in unreliable predictions. Moreover, unlike previous techniques, the multi-stage data processing scheme allows for the automatic generation of predictive classifications using historical data, thereby offering an efficient alternative to the constant surveillance of entities from a variety of data sources which may be resource intensive, intrusive, and require prior authorization.

Moreover, the data structures and predictive classifications presented herein may enable post-processing activities that are not practical using conventional approaches. For example, distribution data objects may be utilized to derive meaningful comparisons across multiple entities. The distribution data objects may be leveraged to generate accurate utilization trends. In addition, peer entity groups may be generated that accurately group entities according to the individual interactions of each entity. Moreover, accurate comparisons across multiple entities may enable the detection of outlying entities, which may be used to generate additional, more granular, predictive classifications or, in some cases, to intelligently investigate fraud, waste, abuse, and/or other negative aspects of an entity.

Example inventive and technologically advantageous embodiments of the present disclosure include: (i) new predictive classification techniques for generating predictive classifications using identifiers (e.g., non-descriptive identifiers such as clinical codes, and/or the like that are publicly available), (ii) new data modeling techniques for incrementally emphasizing predictive components of a set of identifiers that may be leveraged by machine learning models to improve machine learning model accuracy, and (iii) post-processing techniques for generating predictive insights (e.g., investigative outcomes, peer groupings, and/or the like) for a plurality of entities.

Various embodiments of the disclosure are described herein using a number of different example terms, described below.

In some embodiments, the term “entity” refers to a data entity with a corresponding classification. An entity, for example, may be associated with interaction data descriptive of one or more different aspects of the entity. For example, the entity may include a label, identifier, and/or the like that groups a plurality of different interactions. The different interactions may be related to a classification corresponding to the entity. In some embodiments, the classification for the entity may be associated with a specialty in a health care environment. By way of example, the entity may include a health care provider such as a doctor, physician assistant, nurse practitioner, hospitalist, and/or the like who may perform, facilitate, and/or otherwise be involved in one or more interactions related to a specific clinical specialty, and the classification may describe the entity's specialty.

In some embodiments, the term “predictive classification” refers to a data entity that describes an estimated classification for an entity. A predictive classification may describe one or more aspects of an entity. As one example, a predictive classification may describe a type and/or a grouping within which an entity may belong. By way of example, in a clinical use case, a predictive classification may include a predicted clinical specialty for an entity such as a health care provider. The predictive classification, for example, may include a most relevant clinical specialty for the entity based on a portion of a historical interaction dataset corresponding to the entity.

In some embodiments, the term “assigned classification” refers to a data entity that describes an estimated classification for an entity. An assigned classification may include a previously assigned entity classification for an entity. An assigned classification, for example, may describe one or more aspects of an entity. As one example, an assigned classification may describe a type and/or a grouping within which an entity may belong. By way of example, in a clinical use case, an assigned classification may include a previously assigned clinical specialty for an entity such as a health care provider. At times, an assigned classification may be based on user input (e.g., self-reporting, etc.) and thus may be generalized, inaccurate, old, fraudulent, and/or suffer from one or more other defects.

In some embodiments, the term “verification data” refers to a data entity descriptive of a correspondence between an assigned classification and a predictive classification for an entity. The verification data may indicate whether a predictive classification matches an assigned classification (and/or a similarity level therebetween) for an entity. The verification data, for example, may be indicative of a textual similarity, a code similarity, and/or any other measure of similarity between an assigned classification and a predictive classification generated for an entity. In some embodiments, the verification data may include a misclassification indicating that an assigned classification does not match (e.g., does not achieve a threshold similarity level, and/or the like) a predictive classification generated for an entity. In such a case, a predictive classification may be used to refine and/or correct an assigned classification.

In some embodiments, the term “historical interaction dataset” refers to a data entity that describes historical interaction-based information for a plurality of entities. A historical interaction dataset may be based on the entities and/or desired classifications for the entities. In some embodiments, the historical interaction dataset may include a plurality of interaction data objects. Each interaction data object may be descriptive of a recorded interaction (e.g., a data object, record, and/or the like) performed, facilitated, and/or otherwise involved with a particular entity. By way of example, in a clinical context, an interaction data object may include a health care claim created, issued, authorized, and/or otherwise related to an entity. A historical interaction dataset may include a plurality of health care claims respectively associated with each of a plurality of entities, such as a network of health care providers.

In some embodiments, a historical interaction dataset may include a plurality of predictive identifiers. A predictive identifier may include an individual parameter from the historical interaction dataset that, by itself, may be non-descriptive, misleading, or redundant with respect to a classification for an entity. A predictive identifier, for example, may include a parameter from an interaction data object of a historical interaction dataset. A predictive identifier may be based on and vary depending on the use case. In one example, in a clinical context, a predictive identifier may include a parameter from a health care claim. The parameter, for example, may include a clinical code such as an international classification of diseases code (ICD-10), a health care common procedure coding system (HCPCS) code, a current procedural terminology (CPT) code, national drug code (NDC), and/or the like that may be extracted from a health care claim and assigned to an entity associated with the heath care claim.

In some embodiments, the term “predictive identifier count data object” refers to a data entity descriptive of one or more predictive identifiers associated with at least one entity. For instance, a predictive identifier count data object may include frequency data for each predictive identifier associated with a respective entity. Frequency data may be indicative of an identifier count (e.g., a number/frequency of occurrences, and/or the like) for each respective predictive identifier associated with a respective entity. By way of example, for a particular entity, a predictive identifier count data object may identify a separate identifier count for each predictive identifier within at least one interaction data object corresponding to a particular entity. The identifier count may identify a number of times (e.g., a number/frequency of occurrences, etc.) that a predictive identifier is associated with an entity across the interaction data objects of the historical interaction dataset. By way of example, in a clinical context, an identifier count may identify a number of health care claims associated with an entity that include a specific clinical code.

In some embodiments, the term “predictive category data object” refers to a data entity descriptive of one or more predictive categories associated with at least one entity. For instance, the predictive category data object may include frequency data for each predictive category associated with a respective entity. Frequency data may be indicative of a category count (e.g., a number/frequency of occurrences, and/or the like) for a group of predictive identifiers associated with a particular predictive category. A category count, for example, may include an aggregation of a plurality of identifier counts corresponding to a group of predictive identifiers defined by a predictive category.

In some embodiments, a predictive category may define a group of a plurality of predictive identifiers corresponding to a predictive element of a classification. Each particular predictive category, for example, may correspond to a subset of a plurality of predictive identifiers associated with an entity. The predictive category may depend on the entity, the predictive identifiers, and/or a desired classification for the entity. As one example, in a clinical context, a predictive category may include a clinically meaningful category of clinical codes that is predictive of a specialty classification for the entity. In this example, predictive categories may include a first category (e.g., corresponding to a subset of clinical codes related to diabetes), a second category (e.g., corresponding to a subset of clinical codes related to hypertension), a third category (e.g., corresponding to a subset of clinical codes related to statins), a fourth category (e.g., corresponding to a subset of clinical codes related to chemotherapy), and/or the like.

In some embodiments, the term “category type” refers to a group of related predictive categories.

In some embodiments, the term “distribution data object” refers to a data entity that describes a relative distribution of one or more predictive identifiers and/or one or more predictive classifications associated with at least one entity. For instance, a distribution data object may be indicative of a proportional relevance of at least one predictive category associated with an entity. The proportional relevance of a predictive category may describe a category count for a particular category relative to an aggregate category count for each predictive category associated with an entity. An aggregate category count, for example, may include an aggregation of each respective category count for each predictive category associated with an entity. By way of example, an aggregate category count may include the sum of each respective category count. In some embodiments, a relative distribution for a predictive category may include a ratio of (i) a category count for the predictive category to (ii) an aggregate category count for each predictive category associated with an entity.

In some embodiments, the term “type-specific distribution” refers to a relative distribution for one or more predictive categories of a particular category type. For instance, a type-specific distribution may be indicative of a proportional relevance of a predictive category relative to one or more predictive categories associated with a particular category type. The proportional relevance may describe a category count for the particular predictive category relative to a type-specific aggregate category count for each predictive category of the particular category type. By way of example, a proportional relevance for a predictive category may include a ratio of (i) a category count for a predictive category to (ii) a type-specific aggregate category count for each predictive category of the particular category type.

In some embodiments, the term “predictive classification data object” refers to a data entity that describes one or more predictive classifications for an entity. As an example, the predictive classification data object may include a linked list, a table, a vector, and/or any other type of data structure indicative of one or more potential predictive classifications generated for an entity. In some embodiments, each predictive classification data object may include one or more parameters for each predictive classification such as a classification probability, one or more classification tags, a classification grouping, and/or the like.

In some embodiments, the term “peer entity data object” refers to a data entity descriptive of one or more peer entities associated with an entity. The peer entity data object, for example, may include a linked list, a table, a vector, and/or any other type of data structure indicative of a relevance between an entity and at least one peer entity. In some embodiments, the relevance between an entity and at least one peer entity may be based on a distance (e.g., Euclidean distance, Minkowski distance, and/or the like) between distribution data objects respectively associated with the entity and the peer entity. In some embodiments, the peer entity data object is indicative of a plurality of peer entities that are within a threshold distance from the entity. The peer entity data object may include one or more parameters for each peer entity such as a measure of relevance (e.g., distance, etc.), a predictive classification, and/or the like.

In some embodiments, the term “assigned classification distribution data object” refers to a data entity that describes an average distribution data object for an assigned classification. By way of example, an assigned classification distribution data object may include an average proportional relevance for each of a plurality of predictive categories associated with a plurality of entities for which a particular classification (e.g., provider specialty) has been assigned.

In some embodiments, the term “investigative output” refers to an alert, notification, warning, marking, and/or any other indication representative of a potential outlier associated with an entity. By way of example, the investigative output may identify whether a proportional relevance of a predictive category for an entity deviates from an average proportional relevance (e.g., as indicated by an assigned classification distribution data object, and/or the like) by a deviation threshold. In some embodiments, the investigative output may be indicative of a potential for fraud, waste, and/or the like with the entity.

In some embodiments, the term “deviation threshold” refers to a dynamic and/or predetermined numeric, statistical, and/or relative value and/or range. A deviation threshold, for example, may describe a threshold range that, if satisfied, may result in an investigative output. For example, the investigative output may be indicative of a particular predictive category associated with the entity that satisfies a deviation threshold.

In some embodiments, the term “machine learning classification model” refers to a data entity that describes parameters, hyper-parameters, and/or defined operations of a machine learning model (e.g., model including at least one of one or more rule-based layers, one or more layers that depend on trained parameters, coefficients, and/or the like). A machine learning model may be trained to perform a classification, prediction, and/or any other computing task. The machine learning classification model may include one or more of any type of machine learning models including one or more supervised, unsupervised, semi-supervised, and/or reinforcement learning models. In some embodiments, the machine learning classification model may include multiple models configured to perform one or more different stages of a classification, prediction, and/or any other computing task.

As one example, a machine learning classification model may include a predictive classifier trained, using one or more machine learning training techniques, to output a predictive classification describing one or more aspects of an entity. In some embodiments, the predictive classifier may include a linear discriminant analysis classifier. In addition, or alternatively, the predictive classifier may include one or more other machine learning models such as one or more logistic regression models, naïve bayes models, K-nearest Neighbors, support vector machines, neural networks, classification models, and/or the like.

### II. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a nonvolatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a non-transitory computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a non-transitory computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### III. EXAMPLE COMPUTING SYSTEM

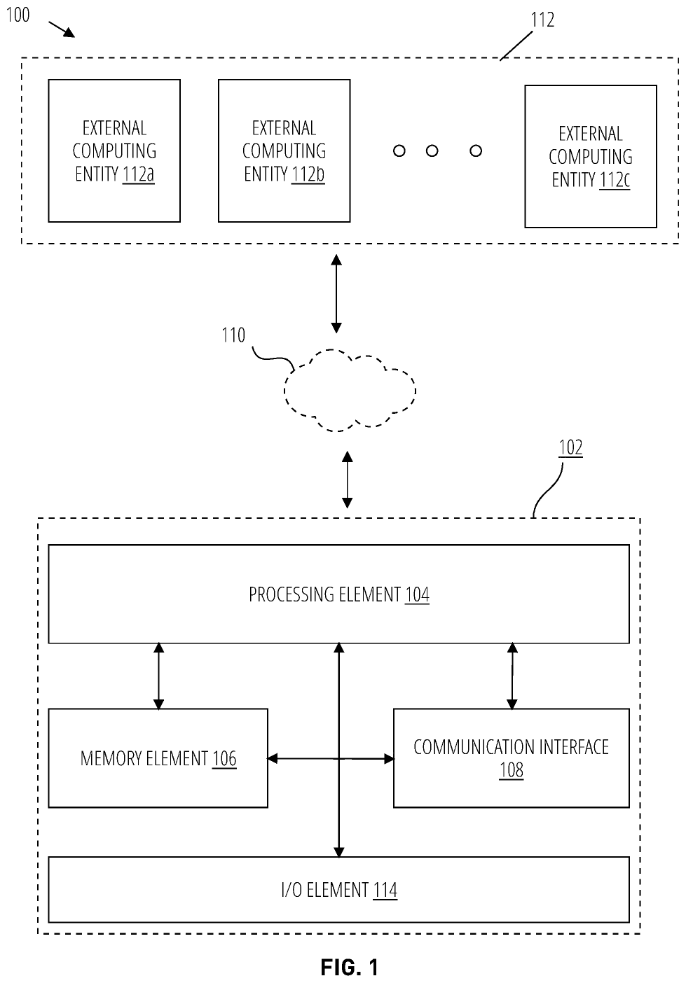

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may be specially configured to perform one or more steps/operations of one or more prediction techniques described herein. In some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more data objects from and/or to the external computing entities 112a-c to perform one or more steps/operations of one or more prediction techniques described herein.

The external computing entities 112a-c, for example, may include and/or be associated with one or more data centers. The data centers, for example, may be associated with one or more data repositories storing data that may, in some circumstances, be processed by the predictive computing entity 102. By way of example, the external computing entities 112a-c may be associated with a plurality of entities. A first example external computing entity 112a, for example, may host a registry for the entities. By way of example, in some example embodiments, the entities may include one or more service providers and the external computing entity 112a may host a registry (e.g., the national provider identifier registry, and/or the like) including one or more clinical profiles for the service providers. In addition, or alternatively, a second example external computing entity 112b may include one or more claim processing entities that may receive, store, and/or have access to a historical interaction dataset for the entities. In some embodiments, a third example external computing entity 112c may include a data processing entity that may preprocess the historical interaction dataset to generate one or more data objects descriptive of one or more aspects of the historical interaction dataset.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways. The predictive computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like may be used to control certain aspects of the operation of the predictive computing entity 102 with the assistance of the processing element 104.

As indicated, in one embodiment, the predictive computing entity 102 may also include one or more communication interfaces 108 for communicating with various computing entities such as the external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

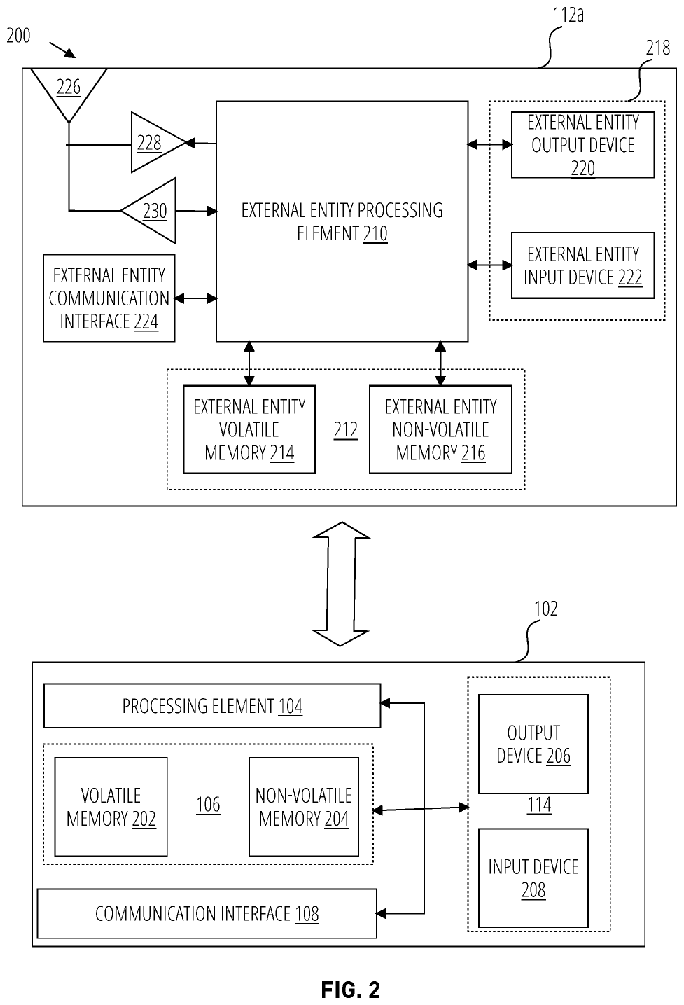

FIG. 2 is a schematic diagram showing a system computing architecture 200 in accordance with some embodiments discussed herein. In some embodiments, the system computing architecture 200 may include the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing element 104, a memory element 106, a communication interface 108, and/or one or more I/O elements 114 that communicate within the predictive computing entity 102 via internal communication circuitry such as a communication bus, and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

The memory element 106 may include non-volatile memory 204 (also referred to as non-volatile storage, memory, memory storage, memory circuitry and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more step/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as in a particular directory, folder, or library. Software components may be static (e.g., pre-established, or fixed) or dynamic (e.g., created, or modified at the time of execution).

The predictive computing entity 102 may be embodied by a computer program product include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry such as a communication bus, and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something to within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### IV. EXAMPLE SYSTEM OPERATIONS

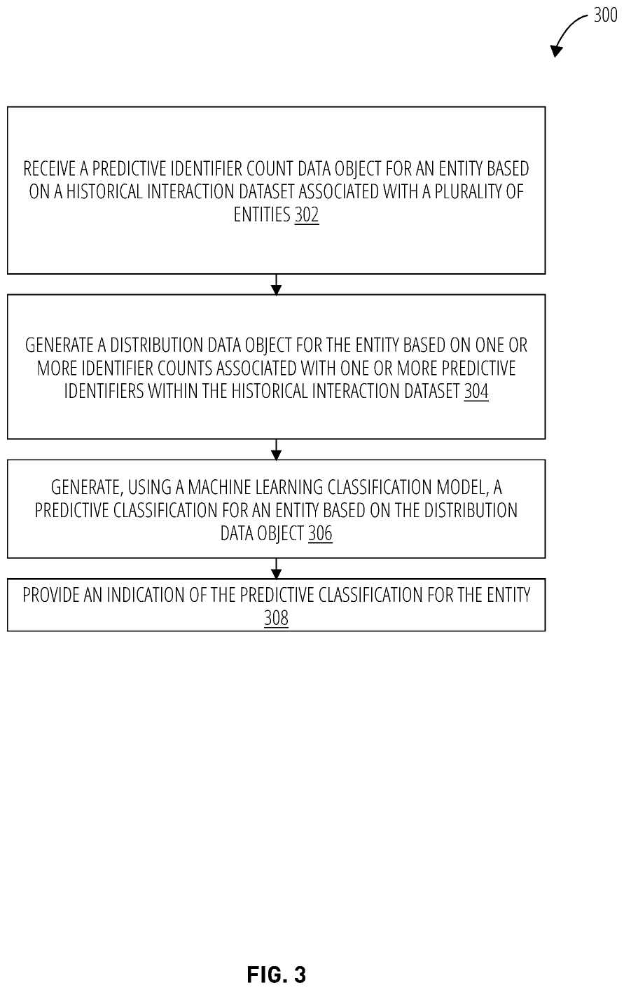

FIG. 3 is a flowchart showing an example of a process 300 for generating predictive insights using distributions of identifiers in accordance with some embodiments discussed herein. The flowchart depicts specific rules-based techniques for automatically generating a predictive classification for an entity based on predictive identifiers for the entity. The rules-based techniques may be implemented by one or more computing devices, entities and/or systems described herein. For example, via the various steps/operations of the process 300, the computing system 100 may leverage the rules-based techniques to overcome the various limitations with conventional predictive classification techniques that are (i) resource intensive and/or time consuming, (ii) unable to automatically generate predictive classifications generally, (iii) rely on descriptive identifiers that may lack accuracy, offer limited scope, and/or are not readily accessible, and/or (iv) generate predictive classifications that lack granularity, accuracy, and consistency.

FIG. 3 illustrates an example process 300 for explanatory purposes. Although the example process 300 depicts a particular sequence of steps/operations, the sequence may be altered without departing from the scope of the present disclosure. For example, some of the steps/operations depicted may be performed in parallel or in a different sequence that does not materially impact the function of the process 300. In other examples, different components of an example device or system that implements the process 300 may perform functions at substantially the same time or in a specific sequence.

The process 300 includes, at step/operation 302, receiving a predictive identifier count data object for an entity based on a historical interaction dataset associated with a plurality of entities. For example, the computing system 100 may receive the predictive identifier count data object for the entity. The predictive identifier count data object may be based on the historical interaction dataset associated with the plurality of entities.

The predictive identifier count data object may be generated by and/or received from one or more different entities of the computing system 100.

For example, in some embodiments, the predictive computing entity 102 may receive the predictive identifier count data object from one or more external computing entities 112a-c. An external computing entity 112a, for example, may receive, generate, store, and/or maintain at least a portion of a historical interaction dataset. The external computing entity 112a may analyze the historical interaction dataset and generate a plurality of predictive identifier count data objects for a plurality of entities based on the historical interaction dataset. The external computing entity 112a may provide at least one predictive identifier count data object from the predictive identifier count data objects to the predictive computing entity 102.

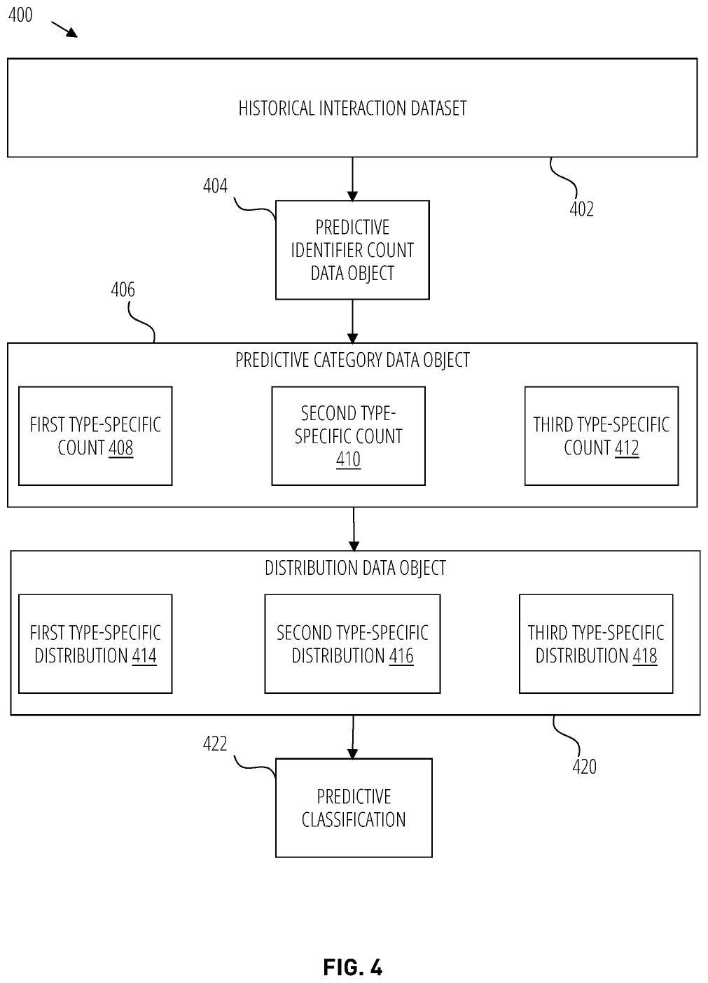

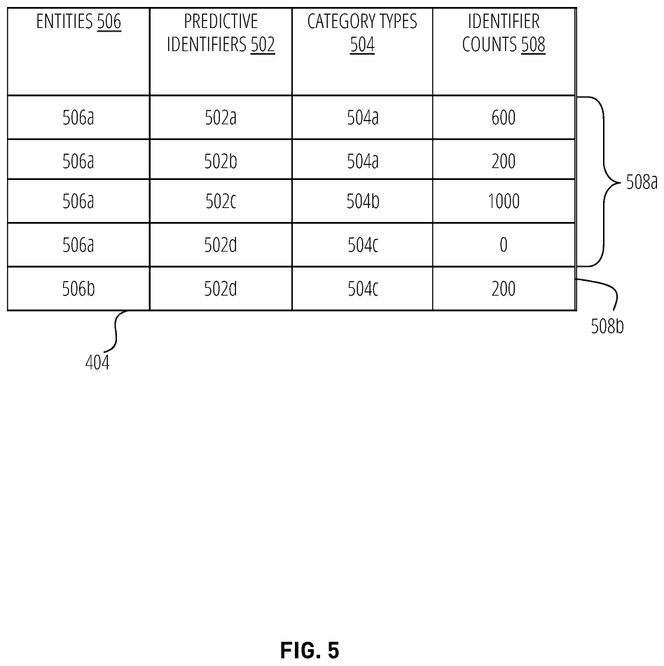

As another example, the predictive computing entity 102 may receive, generate, store, and/or maintain at least a portion of a historical interaction dataset. The predictive computing entity 102 may analyze the historical interaction dataset and generate a plurality of predictive identifier count data objects for a plurality of entities based on the historical interaction dataset. The predictive computing entity 102 may provide at least one predictive identifier count data object from the predictive identifier count data objects to the external computing entity 112a. Examples of the predictive identifier count data object will now further be described with reference to FIGS. 4 and 5.

FIG. 4 provides a dataflow diagram 400 showing example data structures for generating predictive insights using distributions of identifiers in accordance with some embodiments discussed herein. The dataflow diagram 400 depicts a hierarchical set of data objects that incrementally enhance predictive aspects of the identifiers to generate a predictive classification 422 for an entity from a historical interaction.

An entity, for example, may include a data entity with a corresponding classification. An entity, for example, may be associated with interaction data descriptive of one or more different aspects of the entity. For example, the entity may include a label, identifier, and/or the like that groups a plurality of different interactions. The different interactions may be related to a classification corresponding to the entity. In some embodiments, the classification for the entity may be associated with a specialty in a health care environment. By way of example, the entity may include a health care provider such as a doctor, physician assistant, nurse practitioner, hospitalist, and/or the like that may perform, facilitate, and/or otherwise be involved in one or more interactions related to a specific clinical specialty and the classification may describe the entity's specialty.

Data indicative of the interactions associated with a plurality of entities may be stored in a historical interaction dataset 402 for processing by a computing system 100. The historical interaction dataset 402, for example, may include a data entity that describes historical interaction-based information for a plurality of entities. The historical interaction dataset 402 may be based on the entities and/or desired classifications for the entities.

In some embodiments, the historical interaction dataset 402 may include a plurality of interaction data objects. Each interaction data object may be descriptive of a recorded interaction (e.g., a data object, record, and/or the like) performed, facilitated, and/or otherwise involved with a particular entity. By way of example, in a clinical context, an interaction data object may include a health care claim created, issued, authorized, and/or otherwise related to an entity. The historical interaction dataset 402 may include a plurality of health care claims respectively associated with each of a plurality of entities such as a network of health care providers.

The historical interaction dataset 402 may include a plurality of predictive identifiers. A predictive identifier may include an individual parameter from the historical interaction dataset 402 that, by itself, may be non-descriptive, misleading, or redundant with respect to a classification for an entity. A predictive identifier, for example, may include a parameter from an interaction data object of the historical interaction dataset 402. The predictive identifier may be based on and vary depending on the use case. In one example, in a clinical context, a predictive identifier may include a parameter from a health care claim. The parameter, for example, may include a clinical code such as an international classification of diseases code (ICD-10), a healthcare common procedure coding system (HCPCS) code, a current procedural terminology (CPT) code, national drug code (NDC), and/or the like that may be extracted from a health care claim and assigned to an entity associated with the heath care claim.

The predictive identifiers may be, by themselves, uninformative, misleading, or otherwise inadequate for determining a classification for an entity. To compensate for at least some of these deficiencies, a predictive identifier count data object 404 may be generated based on the historical interaction dataset 402.

The predictive identifier count data object 404 may include a data entity descriptive of one or more predictive identifiers associated with at least one entity. For instance, the predictive identifier count data object 404 may include frequency data for each predictive identifier associated with a respective entity. The frequency data may be indicative of an identifier count (e.g., a number/frequency of occurrences, and/or the like) for each respective predictive identifier associated with a respective entity. By way of example, for a particular entity, the predictive identifier count data object 404 may identify a separate identifier count for each predictive identifier within at least one interaction data object corresponding to the particular entity. The identifier count may identify a number of times (e.g., a number/frequency of occurrences, etc.) that a predictive identifier is associated with the entity across the interaction data objects of the historical interaction dataset 402. By way of example, in a clinical context, the identifier count may identify a number of healthcare claims associated with an entity that include a specific clinical code.

FIG. 5 provides an operational example of a predictive identifier count data object 404 in accordance with some embodiments discussed herein. The predictive identifier count data object 404 may include a plurality of identifier counts 508 for a plurality of predictive identifiers 502 associated with one or more entities 506. By way of example, the predictive identifier count data object 404 may include a plurality of first identifier counts 508a for a first entity 506a, a plurality of second identifier counts 508b for a second entity 506b, and/or the like. Each identifier count may be indicative of a number and/or frequency between an entity and a respective predictive identifier. By way of example, the predictive identifier count data object 404 may be indicative of a first identifier count for a first predictive identifier 502a associated with the first entity 506a and a second identifier count for a second predictive identifier 502b associated with the first entity 506a.

As one example, the first identifier count that corresponds to a first predictive identifier 502a and the first entity 506a may be indicative of six hundred counts, the second identifier count that corresponds to a second predictive identifier 502b and the first entity 506a may be indicative of two hundred counts, a third identifier count that corresponds to a third predictive identifier 502c and the first entity 506a may be indicative of one thousand counts, a fourth identifier count that corresponds to a fourth predictive identifier 502d and the first entity 506a may be indicative of zero counts, and/or a fifth identifier count that corresponds to the fourth predictive identifier 502d and the second entity 506b may be indicative of two hundred counts.

In some embodiments, the identifier counts 508 may be associated with an evaluation time period. The evaluation time period may describe a time range during which predictive identifiers 502 may be observed, extracted, and/or the like from interaction data objects. By way of example, the evaluation time period may specify that predictive identifiers 502 may be observed, extracted, and/or the like from interaction data objects obtained, generated, stored, and/or the like within one or more months (e.g., six months, etc.), years (e.g., two years, etc.), etc. In this way, the predictive identifier count data object 404 may include continuously updated metrics descriptive of an entity's activity within a relevant time period.

In some embodiments, the predictive identifier count data object 404 may be indicative of a category type 504 corresponding to one or more of the predictive identifiers 502. A category type, for example, may be indicative of a grouping of related predictive identifiers. In some embodiments, each predictive identifier may be associated with one of a plurality of different category types 504. The plurality of category types 504, for example, may include a first category type 504a, a second category type 504b, and/or a third category type 504c. As one example, the first predictive identifier 502a and/or the second predictive identifier 502b may correspond to the first category type 504a, the third predictive identifier 502c may correspond to the second category type 504b, and/or the fourth predictive identifier 502d may correspond to the third category type 504c.

Turning back to FIG. 3, the process 300 includes, at step/operation 304, generating a distribution data object for the entity based on one or more identifier counts associated with one or more predictive identifiers within the historical interaction dataset. For example, the computing system 100 may generate the distribution data object for the entity based on a first count for a first predictive identifier and/or a second count for a second predictive identifier. The distribution data object may be indicative of a proportional relevance of at least one predictive category associated with the entity. Examples of the distribution data object will now further be described with reference to FIGS. 4 and 6-8.

With reference to FIG. 4, a distribution data object 420 may include one or more type-specific distributions for an entity. In some embodiments, the distribution data object 420 may be based on a predictive category data object 406. The predictive category data object 406, for example, may be generated from the predictive identifier count data object 404. In some embodiments, the predictive category data object 406 may include one or more type-specific counts corresponding to one or more category types associated with a plurality of predictive identifiers. The predictive category data object 406, for example, may include a first type-specific count 408, a second type-specific count 410, and/or a third type-specific count 412. In some embodiments, the type-specific distributions of the distribution data object 420 may include a first type-specific distribution 414 corresponding to the first type-specific count 408, a second type-specific distribution 416 corresponding to the second type-specific count 410, and/or a third type-specific distribution 418 corresponding to the third type-specific count 412.

The distribution data object 420 may be generated based on the predictive identifier count data object 404 and/or the predictive category data object 406 over one or more steps/operations.

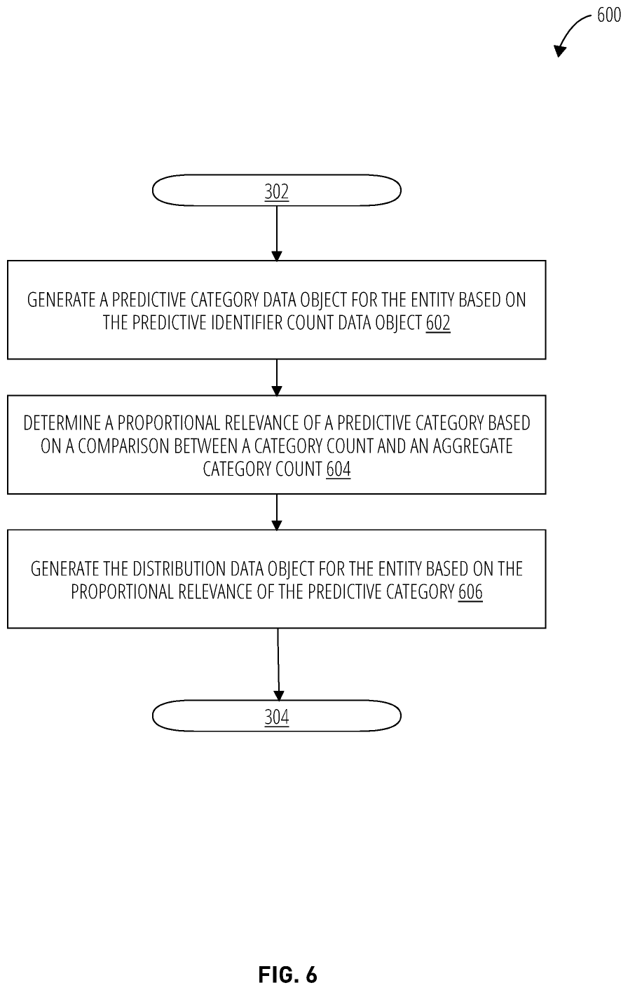

FIG. 6 is a flowchart showing an example of a process 600 for generating a distribution data object in accordance with some embodiments discussed herein. The flowchart depicts specific rules-based techniques for automatically generating a new data structure (e.g., the distribution data object) storing specific data that may be leveraged to improve the automatic generation of predictive classifications for an entity. The distribution data object may be generated by one or more computing devices, entities and/or systems described herein. For example, via the various steps/operations of the process 600, the computing system 100 may generate the distribution data object.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 may include a plurality of operations subsequent to the step/operation 302, where the process 300 includes receiving a predictive identifier count data object for an entity based on a historical interaction dataset associated with a plurality of entities. In addition, or alternatively, the process 600 may include a plurality of operations preceding step/operation 304, where the process 300 includes generating a distribution data object for the entity based on one or more identifier counts associated with one or more predictive identifiers within the historical interaction dataset. In some example embodiments, the process 600 may include one or more suboperations of step/operation 302 and/or step/operation 304.

The process 600 includes, at step/operation 602, generating a predictive category data object for the entity based on the predictive identifier count data object. For example, the computing system 100 may generate the predictive category data object for the entity based on the predictive identifier count data object.

The predictive category data object may include a data entity descriptive of one or more predictive categories associated with at least one entity. For instance, the predictive category data object may include frequency data for each predictive category associated with a respective entity. The frequency data may be indicative of a category count (e.g., a number/frequency of occurrences, and/or the like) for a group of predictive identifiers associated with a particular predictive category. A category count, for example, may include an aggregation of a plurality of identifier counts corresponding to a group of predictive identifiers defined by a predictive category.

A predictive category may define a group of a plurality of predictive identifiers corresponding to a predictive element of a classification. Each particular predictive category, for example, may correspond to a subset of a plurality of predictive identifiers associated with an entity. The predictive category may depend on the entity, the predictive identifiers, and/or a desired classification for the entity. As one example, in a clinical context, a predictive category may include a clinically meaningful category of clinical codes that is predictive of a specialty classification for the entity. In this example, predictive categories may include a first diabetes category (e.g., corresponding to a subset of clinical codes related to diabetes), a second hypertension category (e.g., corresponding to a subset of clinical codes related to hypertension), a third statins category (e.g., corresponding to a subset of clinical codes related to statins), a fourth chemotherapy category (e.g., corresponding to a subset of clinical codes related to chemotherapy), and/or the like.

For a particular entity such as the entity, the predictive category data object may identify a separate category count for each predictive category associated with the entity. A predictive category, for example, may be associated with an entity in the event that the entity is associated with a predictive identifier within a group of predictive identifiers defined by the predictive category. A predictive category data object 406 may include a plurality of category counts for a plurality of predictive categories associated with a particular entity. In addition, or alternatively, the predictive category data object may include a plurality of category counts for a plurality of predictive categories associated with each of a plurality of entities.

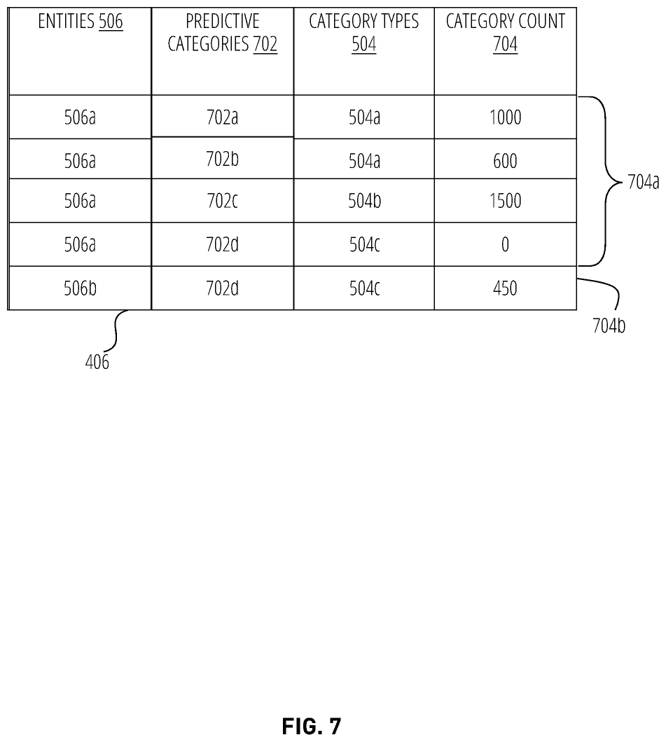

FIG. 7 provides an operational example of a predictive category data object 406 in accordance with some embodiments discussed herein. The predictive category data object 406 may include a plurality of category counts 704 for a plurality of predictive categories 702 associated with one or more entities 506. By way of example, the predictive category data object 406 may include a plurality of first category counts 704a for the first entity 506a, a plurality of second category counts 704b for the second entity 506b, and/or the like. Each category count may be indicative of a number and/or frequency between an entity and a respective predictive category. By way of example, the predictive category data object 406 may be indicative of a first category count for a first predictive category 702a (e.g., an aggregate identifier count for a plurality of predictive identifiers corresponding the first predictive category 702a) associated with the first entity 506a, a second category count for a second predictive category 702b (e.g., an aggregate identifier count for a plurality of predictive identifiers corresponding the second predictive category 702b) associated with the first entity 506a, and/or the like.

As one example, the first category count that corresponds to the first predictive category 702a and the first entity 506a may be indicative of one thousand counts, the second category count that corresponds to the second predictive category 702b and the first entity 506a may be indicative of six hundred counts, a third category count that corresponds to a third predictive category 702c and the first entity 506a may be indicative of one thousand and five hundred counts, a fourth category count that corresponds to a fourth predictive category 702d and the first entity 506a may be indicative of zero counts, and/or a fifth category count that corresponds to the fourth predictive category 702d and the second entity 506b may be indicative of four hundred and fifty counts.

In some embodiments, the predictive category data object 406 may be indicative of one or more predictive categories corresponding to one or more category types 504. The category types 504, for example, may define a group of related predictive categories. By way of example, the first category type 504a may include the first predictive category 702a and the second predictive category 702b, the second category type 504b may include the third predictive category 702c, and/or the third category type may include the fourth predictive category 702d.

In some embodiments, the predictive category data object 406 may be indicative of an aggregate category count corresponding to each predictive category of a respective category type. The aggregate category count, for example, may include an aggregate count (e.g., a sum) of the category counts for each predictive category within a category type.

Turning back to FIG. 6, the process 600 includes, at step/operation 604, determining a proportional relevance of a predictive category based on a comparison between a category count and an aggregate category count. For example, the computing system 100 may determine the particular proportional relevance of the particular predictive category based on the comparison between the category count and the aggregate category count.

The process 600 includes, at step/operation 606, generating the distribution data object for the entity based on the proportional relevance of the predictive category. For example, the computing system 100 may generate the distribution data object for the entity based on the proportional relevance of the predictive category.

The distribution data object may include a data entity descriptive of a relative distribution of one or more predictive identifiers and/or one or more predictive classifications associated with at least one entity. For instance, a distribution data object may be indicative of a proportional relevance of at least one predictive category associated with the entity. The proportional relevance of a predictive category may describe a category count for the particular category relative to an aggregate category count for each predictive category associated with an entity. An aggregate category count, for example, may include an aggregation of each respective category count for each predictive category associated with an entity. By way of example, the aggregate category count may include the sum of each respective category count. In some embodiments, the relative distribution for a predictive category may include a ratio of (i) the category count for the predictive category to (ii) the aggregate category count for each predictive category associated with an entity.

With reference to FIG. 4, in some embodiments, the distribution data object 420 may include a plurality of type-specific distributions. Each type-specific distribution may include a relative distribution for one or more predictive categories of a particular category type. For instance, a type-specific distribution may be indicative of a proportional relevance of a predictive category relative to one or more predictive categories associated with a particular category type. The proportional relevance may describe a category count for the particular predictive category relative to a type-specific aggregate category count for each predictive category of the particular category type. By way of example, the proportional relevance for a predictive category may include a ratio of (i) the category count for the predictive category to (ii) the type-specific aggregate category count for each predictive category of the particular category type.

A predictive category may include one of a plurality of predictive categories associated with one or more different category types. For instance, the predictive categories may include one or more predictive categories respectively associated with one or more different category types. As an example, in a clinical context, a first category type may include one or more predictive categories that correspond to diagnosis codes (e.g., diabetes, hypertension, and/or the like), a second category type may include one or more predictive categories that correspond to pharmacy codes (e.g., statins, and/or the like), and/or a third category type may include one or more predictive categories that correspond to procedure codes (e.g., chemotherapy, and/or the like). Each category type may define a plurality of predictive categories. Each predictive category may define a plurality of predictive identifiers.

In some embodiments, the distribution data object 420 may include a first type-specific distribution 414 corresponding to the first category type, a second type-specific distribution 416 corresponding to the second category type, and a third type-specific distribution 418 corresponding to the third category type.

In some embodiments, the distribution data object 420 may be represented by a predictive category vector including a plurality of data entries indicative of the proportional relevance of each predictive category associated with the entity. The proportional relevance, for example, may include a type-specific proportional relevance and/or a non-type-specific proportional relevance for each predictive category. In some embodiments, a comparison between two distribution data objects may include a distance (e.g., Euclidean distance) between predictive category vectors of each distribution data object.

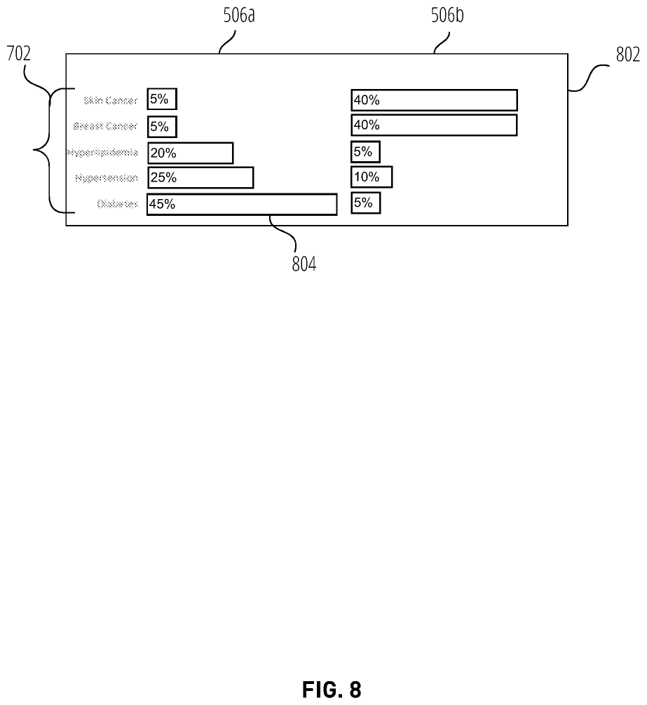

FIG. 8 provides an operational example of a type-specific distribution 802 in accordance with some embodiments discussed herein. The type-specific distribution 802 may be indicative of a respective proportional relevance of each predictive category within a category type to an entity. For example, the type-specific distribution 802 may include a first distribution for the first entity 506a and/or a second distribution for a second entity 506b. The first distribution and the second distribution may each be indicative of a respective proportional relevance, such as proportional relevance 804, for each of a plurality of predictive categories 702 relative to the first entity 506a and the second entity 506b, respectively.

Turning back to FIG. 3, the process 300 includes, at step/operation 306, generating, using a machine learning classification model, a predictive classification for an entity based on the distribution data object. For example, the computing system 100 may generate, using the machine learning classification model, a predictive classification for the entity based on the distribution data object.

The machine learning classification model may include a data entity that describes parameters, hyper-parameters, and/or defined operations of a machine learning model (e.g., model including at least one of one or more rule-based layers, one or more layers that depend on trained parameters, coefficients, and/or the like). A machine learning model may be trained to perform a classification, prediction, and/or any other computing task. The machine learning classification model may include one or more of any type of machine learning models including one or more supervised, unsupervised, semi-supervised, and/or reinforcement learning models. In some embodiments, the machine learning classification model may include multiple models configured to perform one or more different stages of a classification, prediction, etc. computing task.

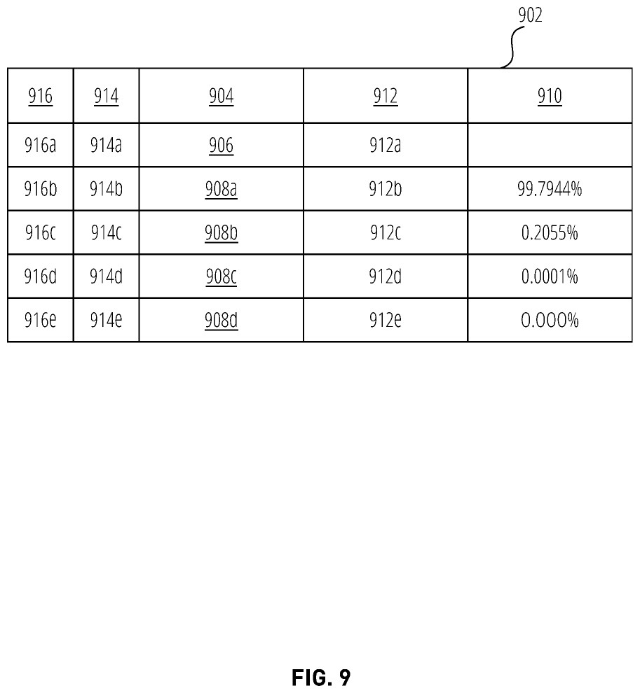

As one example, a machine learning classification model may include a predictive classifier trained, using one or more machine learning training techniques, to output a predictive classification describing one or more aspects of an entity. In some embodiments, the predictive classifier may include a linear discriminant analysis classifier. In addition, or alternatively, the predictive classifier may include one or more other machine learning models such as one or more logistic regression models, naïve bayes models, K-nearest Neighbors, support vector machines, neural networks, classification models, and/or the like. Examples of the predictive classification will now further be described with reference to FIGS. 4 and 9.

With reference to FIG. 4, the predictive classification 422 for a respective entity may be based on a distribution data object 420 for the respective entity. For example, the machine learning classification model may be trained to receive the distribution data object 420 and output a predictive classification data object based on the distribution data object 420. The predictive classification 422 may include at least one portion of the predictive classification data object.

The predictive classification data object, for example, may include a data entity that is descriptive of one or more predictive classifications for an entity. As an example, the predictive classification data object may include a linked list, a table, a vector, and/or any other type of data structure indicative of one or more potential predictive classifications generated for an entity. In some embodiments, each predictive classification data object may include one or more parameters for each predictive classification such as a classification probability, one or more classification tags, a classification grouping, and/or the like. The predictive classification 422 for an entity may include one or more predictive classifications from the predictive classification data object that achieve a probability threshold (e.g., over 50%, 80%, 95% classification probability and/or the like). In some embodiments, the predictive classification 422 may include a subset of predictive classifications from the predictive classification data object. The number of the subset of predictive classifications may be preset and/or dynamically set based on one or more factors. By way of example, a user may dynamically set the number of the subset of predictive classifications based on a desired granularity of the predictive classification. A higher level of granularity, for example, may be achieved by increasing the number of predictive classifications, whereas a lower level of granularity may be achieved by decreasing the number of predictive classifications. In this manner, the predictive classification data object may enable the dynamic adjustment of classification granularity for a plurality of different entities based on one or more different circumstances.

FIG. 9 provides an operational example of a predictive classification data object 902 in accordance with some embodiments discussed herein. The predictive classification data object 902 may be indicative of one or more entity classification 904 for at least one entity. The entity classifications 904, for example, may include an assigned classification 906 and/or one or more predictive classifications 908a-d.

The assigned classification 906 may include a previously assigned entity classification for an entity. The assigned classification 906, for example, may describe one or more aspects of an entity. As one example, the assigned classification may describe a type and/or a grouping within which an entity may belong. By way of example, in a clinical use case, the assigned classification 906 may include a previously assigned clinical specialty for an entity such as a health care provider. At times, the assigned classification 906 may be based on user input (e.g., self-reporting, etc.) and may be generalized, inaccurate, old, fraudulent, and/or suffer from one or more other defects.

The predictive classifications 908a-d may include one or more entity classifications automatically generated for the entity based on the historical interaction dataset using the techniques described herein. Each predictive classification may describe one or more aspects of an entity. As one example, a predictive classification may describe a type and/or a grouping within which an entity may belong. By way of example, in a clinical use case, the predictive classification may include a predicted clinical specialty for an entity such as a health care provider. The predictive classification, for example, may include a most relevant clinical specialty for the entity based on a portion of a historical interaction dataset corresponding to the entity.

The predictive classification data object 902 may include one or more contextual attributes for one or more of the entity classifications 904. By way of example, the predictive classification data object 902 may include one or more classification tags 916a-e (e.g., tax codes, and/or the like), one or more specialty groupings 914a-e (e.g., clinical classification groupings, and/or the like), one or more specializations 912a-e (e.g., clinical sub-specialties, and/or the like), one or more classification probabilities 910, and/or any other information associated with one or more of the entity classifications 904.

In some embodiments, the predictive classification data object 902 may include a classification probability 910 for each of one or more predictive classifications 908a-d. The classification probability 910, for example, may represent a predicted relevance between a respective predictive classification and an entity. For example, the predictive classification data object 902 include a first classification probability of 99.7944% for a first predictive classification 908a, a second classification probability of 0.2055% for a second predictive classification 908b, a third classification probability of 0.0001% for a third predictive classification 908c, and/or a fourth classification probability of 0.0000% for a fourth predictive classification 908d.

Turning back to FIG. 3, the process 300 includes, at step/operation 308, providing an indication of the predictive classification for the entity. For example, the computing system 100 may provide an indication of the predictive classification for the entity.

The indication of the predictive classification for the entity may be indicative of the most relevant predictive classification (e.g., associated with a highest classification probability and/or the like). In addition, or alternatively, the indication of the predictive classification for the entity may be indicative of one or more predictive classifications from the predictive classification data object that achieve a probability threshold as described herein. In some embodiments, the indication of the predictive classification may be indicative of a verification of a previously assigned classification and/or a misclassification for an entity.

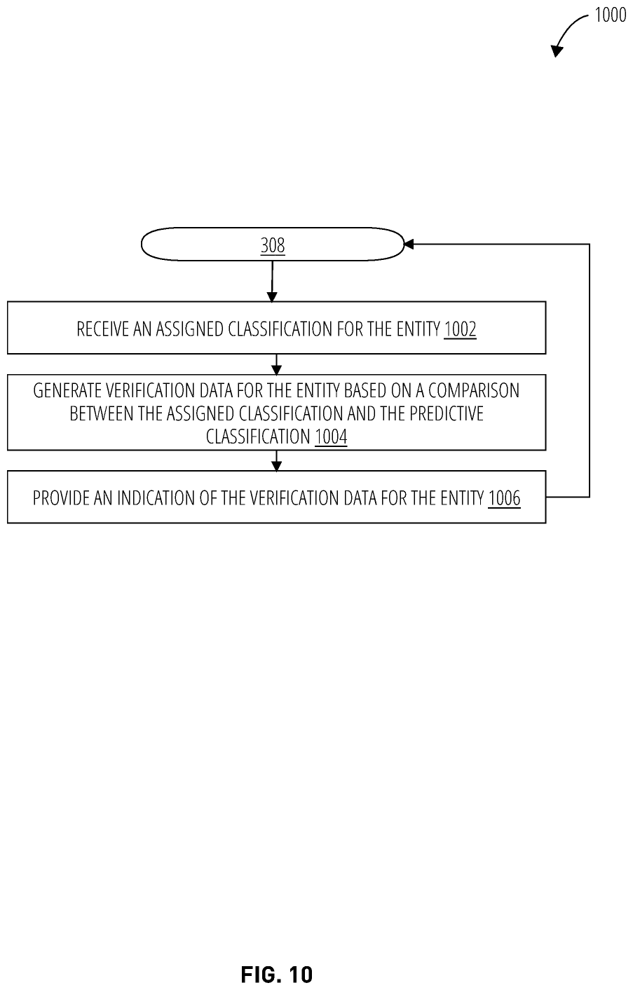

FIG. 10 is a flowchart showing an example of a process 1000 for verifying an assigned classification for an entity in accordance with some embodiments discussed herein. The flowchart depicts one or more post-processing actions enabled by the specific rules-based techniques described herein. The post-processing actions may be performed by one or more computing devices, entities and/or systems described herein. For example, via the various steps/operations of the process 1000, the computing system 100 may implement the post-processing actions to improve computer-based monitoring, tracking, and/or validation systems that traditionally rely on outdated, inaccurate, misleading, and/or generalized predictive classifications that lack granularity.

FIG. 10 illustrates an example process 1000 for explanatory purposes. Although the example process 1000 depicts a particular sequence of steps/operations, the sequence may be altered without departing from the scope of the present disclosure. For example, some of the steps/operations depicted may be performed in parallel or in a different sequence that does not materially impact the function of the process 1000. In other examples, different components of an example device or system that implements the process 1000 may perform functions at substantially the same time or in a specific sequence.

In some embodiments, the process 1000 includes a plurality of operations subsequent to the step/operation 308, where the process 300 includes providing an indication of the predictive classification for the entity. In addition, or alternatively, the process 1000 may include one or more suboperations of step/operation 308. By way of example, the indication of the predictive classification for the entity may include verification data as described herein.

The process 1000 includes, at step/operation 1002, receiving an assigned classification for the entity. For example, a computing system 100 may receive the assigned classification for the entity. The assigned classification may include an entity classification for an entity that has been previously assigned and made available through one or more different data repositories. By way of example, in some embodiments, the entity may be associated with an entity profile that describes an assigned classification for the entity. The entity profile, for example, may be hosted by an external computing entity such as external computing entity 112a.

The process 1000 includes, at step/operation 1004, generating verification data for the entity based on a comparison between the assigned classification and the predictive classification. For example, the computing system 100 may generate the verification data for the entity based on the comparison between the assigned classification and a predictive classification (e.g., a most relevant predictive classification, and/or the like) for the entity.

The verification data may include a data entity descriptive of a correspondence between an assigned classification and a predictive classification for an entity. The verification data may indicate whether the predictive classification matches (and/or a similarity level between) an assigned classification for an entity. The verification data, for example, may be indicative of a textual similarity, a code similarity, and/or any other measure of similarity between an assigned classification and a predictive classification generated for an entity. In some embodiments, the verification data may include a misclassification indicating that the assigned classification does not match (e.g., achieve a threshold similarity level, and/or the like) a predictive classification generated for an entity. In such a case, the predictive classification may be used to refine and/or correct the assigned classification.

The process 1000 includes, at step/operation 1006, providing an indication of the verification data for the entity. For example, the computing system 100 may provide the indication of the verification data for the entity. In some embodiments, responsive to a determination that the assigned classification does not match the predictive classification for the entity, the computing system 100 may generate verification data indicative of a misclassification for the entity and/or provide an alert, notification, and/or the like for the entity.

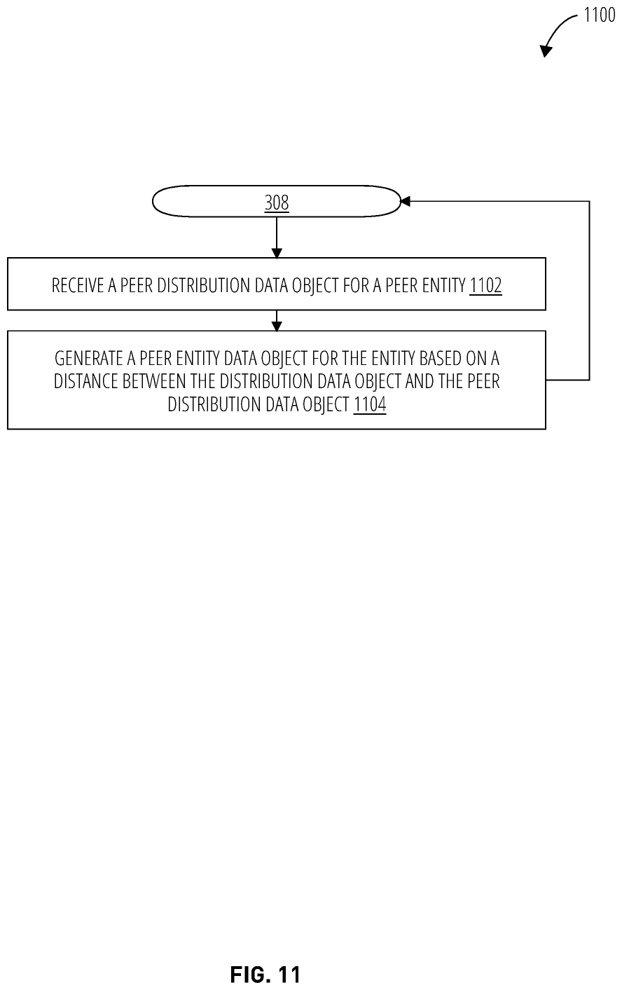

FIG. 11 is a flowchart showing an example of a process 1100 for generating a peer entity data object in accordance with some embodiments discussed herein. The flowchart depicts one or more post-processing actions enabled by the specific rules-based techniques described herein. The post-processing actions may be performed by one or more computing devices, entities and/or systems described herein. For example, via the various steps/operations of the process 1100, the computing system 100 may implement the post-processing actions to improve computer-based monitoring, tracking, and/or validation systems that traditionally rely on outdated, inaccurate, misleading, and/or generalized predictive classifications that lack granularity.

FIG. 11 illustrates an example process 1100 for explanatory purposes. Although the example process 1100 depicts a particular sequence of steps/operations, the sequence may be altered without departing from the scope of the present disclosure. For example, some of the steps/operations depicted may be performed in parallel or in a different sequence that does not materially impact the function of the process 1100. In other examples, different components of an example device or system that implements the process 1100 may perform functions at substantially the same time or in a specific sequence.

In some embodiments, the process 1100 includes a plurality of operations subsequent to the step/operation 308, where the process 300 includes providing an indication of the predictive classification for the entity. In addition, or alternatively, the process 1100 may include one or more suboperations of step/operation 308. By way of example, the indication of the predictive classification for the entity may include a peer entity data object and/or one or more insights derived therefrom.

The process 1100 includes, at step/operation 1102, receiving a peer distribution data object for a peer entity. For example, the computing system 100 may receive the peer distribution data object for the peer entity. The peer entity, for example, may include a second entity that may be related to the entity. For instance, two entities may be related in the event that each entity is individually associated (e.g., performs, supervises, and/or the like) with a plurality of similar interactions. The peer distribution data object may refer to a respective distribution data object for the peer entity that is representative of the similar interactions.

The process 1100 includes, at step/operation 1104, generating a peer entity data object for the entity based on a distance between the distribution data object and the peer distribution data object. For example, the computing system 100 may generate the peer entity data object for the entity based on a distance between the distribution data object and the peer distribution data object.

The peer entity data object may include a data entity descriptive of one or more peer entities associated with an entity. The peer entity data object, for example, may include a linked list, a table, a vector, and/or any other type of data structure indicative of a relevance between an entity and at least one peer entity. In some embodiments, the relevance between an entity and at least one peer entity may be based on a distance (e.g., Euclidean distance, Minkowski distance, and/or the like) between distribution data objects respectively associated with the entity and the peer entity. In some embodiments, the peer entity data object may be indicative of a plurality of peer entities that are within a threshold distance from the entity. The peer entity data object may include one or more parameters for each peer entity such as a measure of relevance (e.g., distance, etc.), a predictive classification, and/or the like.

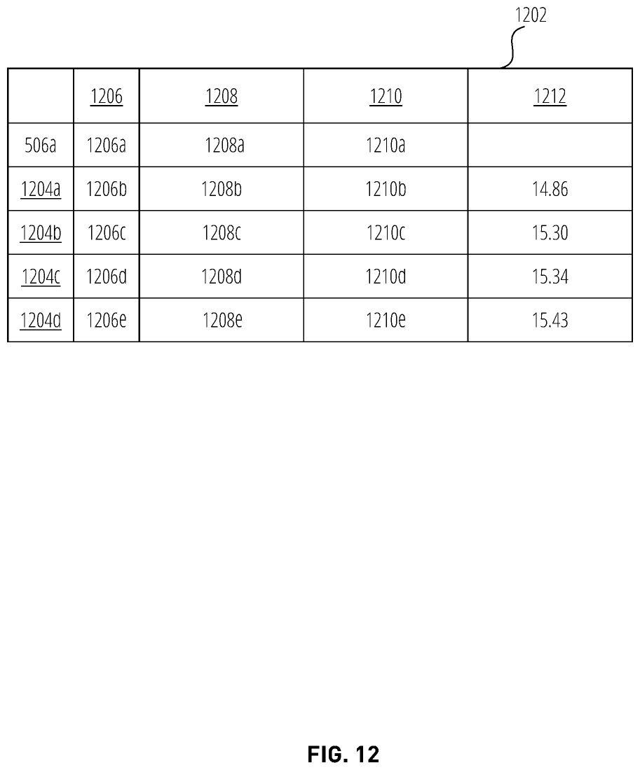

FIG. 12 provides an operational example of a peer entity data object 1202 in accordance with some embodiments discussed herein. The peer entity data object 1202 may be indicative of one or more peer entities 1204a-d for an entity 506a. The peer entity data object 1202 may be indicative of a peer relevance score 1212 for each of the peer entities 1204a-d that described a relevance between a peer entity 1204a-d and the entity 506a. In the example shown, the peer relevance score 1212 may include distance score in which a lower distance is indicative of a greater similarity between the peer entity 1204a-d and the entity 506a. However, any type of similarity scoring technique may be used. In the example shown, the peer entity data object 1202 may include a first peer relevance score of 14.86 for a first peer entity 1204a (e.g., a most relevant peer entity), a second peer relevance score of 15.30 for a second peer entity 1204b (e.g., a second most relevant peer entity), a third peer relevance score of 15.34 for a third peer entity 1204c (e.g., a third most relevant peer entity), and/or a fourth peer relevance score of 15.43 for a fourth peer entity 1204d (e.g., a fourth most relevant peer entity).

The peer entity data object 1202 may include one or more contextual attributes for the entity 506a and/or the of the peer entities 1204a-d. By way of example, the peer entity data object 1202 may include one or more identifier 1206a-e (e.g., national provider identifiers (NPI), and/or the like), one or more entity classification tags 1208a-e (e.g., tax code classifications, and/or the like), one or more classifications 1210a-c, and/or any other information associated with one or more of the classifications 1210a-c.

Turning back to FIG. 11, the distribution data object may include a first predictive category vector that comprises one or more proportional values corresponding to one or more predictive categories associated with the entity. The peer distribution data object may include a second predictive category vector that comprises one or more second proportional values corresponding to one or more second predictive categories associated with the peer entity. The relevance of a peer entity to the entity may be represented by a distance between the distribution data object and the peer distribution data object. The distance may include a Euclidean distance between the first predictive category vector and the second predictive category vector.

In some embodiments, a predictive classification for a plurality of entities may be selected from a defined, non-inclusive list of predictive classifications. The list of predictive classifications may, in some embodiments, be dynamically modified using a plurality of distribution data objects for the entities. For instance, a target entity may be identified that is associated with an entity classification that is not defined by the list of predictive classifications. A peer entity data object may be generated for the target entity. Using the peer entity data object, a predictive classification data object may be generated based on a subset of the entities that are within a similarity threshold to the target entity. The list of predictive classifications may be augmented with a new predictive classification for the target entity and associated with the predictive classification data object. In this way, the techniques of the present disclosure may enable the intelligent and automatic augmentation of a list of predictive classifications for a plurality of entities based on interactions of the entities (e.g., as represented by respective distribution data objects, and/or the like).

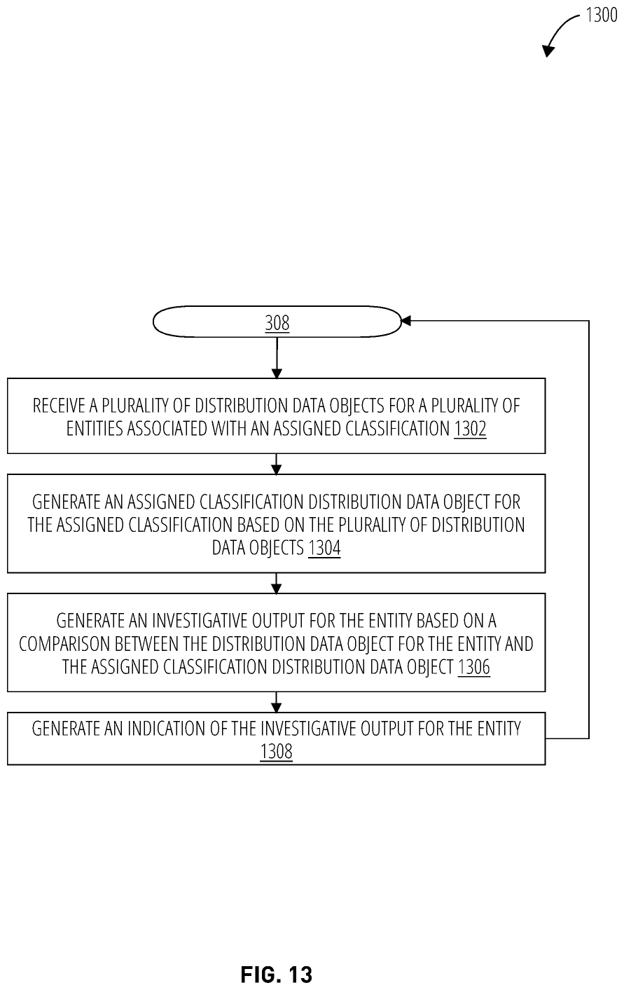

FIG. 13 is a flowchart showing an example of a process 1300 for investigating an entity in accordance with some embodiments discussed herein. The flowchart depicts one or more post-processing actions enabled by the specific rules-based techniques described herein. The post-processing actions may be performed by one or more computing devices, entities and/or systems described herein. For example, via the various steps/operations of the process 1300, the computing system 100 may implement the post-processing actions to improve computer-based monitoring, tracking, and/or validation systems that traditionally rely on outdated, inaccurate, misleading, and/or generalized predictive classifications that lack granularity.

FIG. 13 illustrates an example process 1300 for explanatory purposes. Although the example process 1300 depicts a particular sequence of steps/operations, the sequence may be altered without departing from the scope of the present disclosure. For example, some of the steps/operations depicted may be performed in parallel or in a different sequence that does not materially impact the function of the process 1300. In other examples, different components of an example device or system that implements the process 1300 may perform functions at substantially the same time or in a specific sequence.

In some embodiments, the process 1300 may include a plurality of operations subsequent to the step/operation 308, where the process 300 includes providing an indication of the predictive classification for the entity. In addition, or alternatively, the process 1300 may include one or more suboperations of step/operation 308. By way of example, the indication of the predictive classification for the entity may include an investigative output as described herein.

The process 1300 includes, at step/operation 1302, receiving a plurality of distribution data objects for a plurality of entities associated with an assigned classification. The computing system 100 may receive the distribution data objects for the entities associated with the assigned classification.

The process 1300 includes, at step/operation 1304, generating an assigned classification data object for an assigned classification based on the distribution data objects. The computing system 100 may generate the assigned classification distribution data object for the assigned classification based on the distribution data objects.

A assigned classification distribution data object may describe an average distribution data object for an assigned classification. By way of example, a assigned classification distribution data object may include an average proportional relevance for each of a plurality of predictive categories associated with a plurality of entities for which a particular assigned classification has been generated.

The process 1300 includes, at step/operation 1306, generating an investigative output for the entity based on a comparison between the distribution data object for the entity and the assigned classification distribution data object. For example, the computing system 100 may generate the investigative output for the entity based on a comparison between the distribution data object for the entity and the assigned classification distribution data object.

The investigative output, for example, may include an alert, notification, warning, marking, and/or any other indication representative of a potential outlier associated with an entity. By way of example, the investigative output may identify whether a proportional relevance of a predictive category for an entity deviates from an average proportional relevance (e.g., as indicated by an assigned classification distribution data object, and/or the like) by a deviation threshold. In some embodiments, the investigative output may be indicative of a potential for fraud, waste, and/or the like with the entity. By way of example, the investigative output may be indicative of an entity associated with an assigned classification (e.g., a family practice provider) that is engaged in activities (e.g., prescribing pain management medicines) typically engaged in by another classification (e.g., pain management specialists). In this case, the investigative output may identify the entity's behavior as inappropriate for the assigned classification.

By way of example, the investigative output may be based on a deviation threshold associated with the assigned classification. A deviation threshold may include a dynamic and/or predetermined numeric, statistical, and/or relative value and/or range. A deviation threshold, for example, may describe a threshold range that, if satisfied, may result in an investigative output. For example, the investigative output may be indicative of a particular predictive category associated with the entity that satisfies a deviation threshold.

In some embodiments, a deviation threshold may include a general threshold range applicable to any predictive category, entity, and/or assigned classification. In addition, or alternatively, the deviation threshold may be one of a plurality of deviation thresholds in which each deviation threshold respectively corresponds to a predictive category-classification pair. Such a deviation threshold, for example, may include a threshold range for the proportional relevance of a predictive category for an entity associated with an assigned classification. If satisfied, the deviation threshold may result in an investigative output to investigate whether the entity is associated with fraud, waste, abuse, and/or the like. In some embodiments, one or more deviation thresholds for an assigned classification may be based on an assigned classification distribution data object corresponding to another assigned classification different from the assigned classification for an entity.

The process 1300 includes, at step/operation 1308, generating an indication of the investigative output for the entity. For example, the computing system 100 may generate an indication of the investigative output for the entity. The investigative output may be provided to a user, an external computing entity such as external computing entities 112a-c, and/or the like.

### V. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VI. EXAMPLES

Example 1. A computer-implemented method comprising: receiving, by one or more processors, a predictive identifier count data object for an entity based on a historical interaction dataset associated with a plurality of entities, wherein the predictive identifier count data object is indicative of one or more identifier counts for one or more predictive identifiers associated with the entity; generating, by the one or more processors and using a machine learning classification model, a predictive classification for the entity based on the one or more identifier counts; and providing, by the one or more processors, an indication of the predictive classification for the entity.

Example 2. The computer-implemented method of example 1 wherein the one or more identifier counts for the one or more predictive identifiers comprise (a) a first identifier count for a first predictive identifier associated with the entity and (b) a second identifier count for a second predictive identifier associated with the entity.

Example 3. The computer-implemented method of example 2 further comprising generating, by the one or more processors, a distribution data object for the entity based on the first identifier count and the second identifier count, wherein the distribution data object is indicative of a proportional relevance of a predictive category associated with the entity, and wherein generating the predictive classification is based on the distribution data object.

Example 4. The computer-implemented method of example 3 further comprising receiving, by the one or more processors, a peer distribution data object for a peer entity; and generating, by the one or more processors, a peer entity data object for the entity based on a distance between the distribution data object and the peer distribution data object.

Example 5. The computer-implemented method of example 4 wherein the distribution data object comprises a first predictive category vector that comprises one or more first proportional values corresponding to one or more first predictive categories associated with the entity, the peer distribution data object comprises a second predictive category vector that comprises one or more second proportional values corresponding to one or more second predictive categories associated with the peer entity, and the distance between the distribution data object and the peer distribution data object comprises a particular distance between the first predictive category vector and the second predictive category vector.

Example 6. The computer-implemented method of any of examples 3 to 5 further comprising receiving, by the one or more processors, a plurality of distribution data objects for the plurality of entities associated with an assigned classification; generating, by the one or more processors, an assigned classification distribution data object for the assigned classification based on the plurality of distribution data objects; generating, by the one or more processors, an investigative output for the entity based on a comparison between the distribution data object for the entity and the assigned classification data object; and generating, by the one or more processors, an indication of the investigative output for the entity.

Example 7. The computer-implemented method of example 6 wherein the investigative output is based on a deviation threshold associated with the assigned classification.

Example 8. The computer-implemented method of example 7 wherein the investigative output is indicative of a particular predictive category associated with the entity that satisfies the deviation threshold.

Example 9. The computer-implemented method of any of examples 3 to 8 wherein generating the distribution data object comprises: generating, by the one or more processors, a predictive category data object for the entity based on the predictive identifier count data object, wherein the predictive category data object is indicative of: (i) one or more predictive categories corresponding to a category type, wherein a particular predictive category of the one or more predictive categories corresponds to a subset of a plurality of predictive identifiers associated with the entity, (ii) a category count corresponding to the particular predictive category, and (iii) an aggregate category count corresponding to each of the one or more predictive categories; determining, by the one or more processors, a particular proportional relevance of the particular predictive category based on a comparison between the category count and the aggregate category count; and generating, by the one or more processors, the distribution data object for the entity based on the particular proportional relevance.

Example 10. The computer-implemented method of example 9 wherein the category type is one of a plurality of category types, and wherein the distribution data object comprises a plurality of type-specific distributions corresponding to the plurality of category types.

Example 11. The computer-implemented method of any of the preceding examples further comprising receiving, by the one or more processors, an assigned classification for the entity; generating, by the one or more processors, verification data for the entity based on a comparison between the assigned classification and the predictive classification; and providing, by the one or more processors, an indication of the verification data for the entity.

Example 12. The computer-implemented method of example 11 wherein providing the indication of the verification data comprises providing, by the one or more processors, an alert indicative of a misclassification for the entity responsive to a determination that the assigned classification does not match the predictive classification.

Example 13. A computing apparatus comprising one or more processors and memory including program code, the memory and the program code configured to, when executed by the one or more processors, cause the one or more processors to: receive a predictive identifier count data object for an entity based on a historical interaction dataset associated with a plurality of entities, wherein the predictive identifier count data object is indicative of one or more identifier counts for one or more predictive identifiers associated with the entity; generate, using a machine learning classification model, a predictive classification for the entity based on the one or more identifier counts; and provide an indication of the predictive classification for the entity.

Example 14. The computing apparatus of example 13 wherein the one or more identifier counts for the one or more predictive identifiers comprise (a) a first identifier count for a first predictive identifier associated with the entity and (b) a second identifier count for a second predictive identifier associated with the entity.

Example 15. The computing apparatus of example 14 further configured to generate a distribution data object for the entity based on the first identifier count and the second identifier count, wherein the distribution data object is indicative of a proportional relevance of a predictive category associated with the entity, and wherein generating the predictive classification is based on the distribution data object.

Example 16. A computer program product comprising a non-transitory computer-readable storage medium, the non-transitory computer-readable storage medium including instructions that, when executed by one or more processors, cause the one or more processors to: receive a predictive identifier count data object for an entity based on a historical interaction dataset associated with a plurality of entities, wherein the predictive identifier count data object is indicative of one or more identifier counts for one or more predictive identifiers associated with the entity; generate, using a machine learning classification model, a predictive classification for the entity based on the one or more identifier counts; and provide an indication of the predictive classification for the entity.

Example 17. The computer program product of example 16 wherein the one or more identifier counts for the one or more predictive identifiers comprise (a) a first identifier count for a first predictive identifier associated with the entity and (b) a second identifier count for a second predictive identifier associated with the entity.

Example 18. The computer program product of example 17 further configured to: generate a distribution data object for the entity based on the first identifier count and the second identifier count, wherein the distribution data object is indicative of a proportional relevance of a predictive category associated with the entity, and wherein generating the predictive classification is based on the distribution data object.

Example 19. The computer program product of example 18 further configured to: receive a plurality of distribution data objects for the plurality of entities associated with an assigned classification; generate an assigned classification distribution data object for the assigned classification based on the plurality of distribution data objects; generate an investigative output for the entity based on a comparison between the distribution data object for the entity and the assigned classification data object; and generate an indication of the investigative output for the entity.

Example 20. The computer program product of example 19 wherein the investigative output is based on a deviation threshold associated with the assigned classification.

1. A computer-implemented method comprising:
receiving, by one or more processors, a predictive identifier count data object for an entity based on a historical interaction dataset associated with a plurality of entities, wherein the predictive identifier count data object is indicative of one or more identifier counts for one or more predictive identifiers associated with the entity;
generating, by the one or more processors and using a machine learning classification model, a predictive classification for the entity based on the one or more identifier counts; and
providing, by the one or more processors, an indication of the predictive classification for the entity.

2. The computer-implemented method of claim 1 wherein the one or more identifier counts for the one or more predictive identifiers comprise (a) a first identifier count for a first predictive identifier associated with the entity and (b) a second identifier count for a second predictive identifier associated with the entity.

3. The computer-implemented method of claim 2 further comprising:
generating, by the one or more processors, a distribution data object for the entity based on the first identifier count and the second identifier count, wherein the distribution data object is indicative of a proportional relevance of a predictive category associated with the entity, and
wherein generating the predictive classification is based on the distribution data object.

4. The computer-implemented method of claim 3 further comprising:
receiving, by the one or more processors, a peer distribution data object for a peer entity; and
generating, by the one or more processors, a peer entity data object for the entity based on a distance between the distribution data object and the peer distribution data object.

5. The computer-implemented method of claim 4 wherein:
the distribution data object comprises a first predictive category vector that comprises one or more first proportional values corresponding to one or more first predictive categories associated with the entity,
the peer distribution data object comprises a second predictive category vector that comprises one or more second proportional values corresponding to one or more second predictive categories associated with the peer entity, and
the distance between the distribution data object and the peer distribution data object comprises a particular distance between the first predictive category vector and the second predictive category vector.

6. The computer-implemented method of claim 3 further comprising:
receiving, by the one or more processors, a plurality of distribution data objects for the plurality of entities associated with an assigned classification;
generating, by the one or more processors, an assigned classification distribution data object for the assigned classification based on the plurality of distribution data objects;
generating, by the one or more processors, an investigative output for the entity based on a comparison between the distribution data object for the entity and the assigned classification distribution data object; and
generating, by the one or more processors, an indication of the investigative output for the entity.

7. The computer-implemented method of claim 6 wherein the investigative output is based on a deviation threshold associated with the assigned classification.

8. The computer-implemented method of claim 7 wherein the investigative output is indicative of a particular predictive category associated with the entity that satisfies the deviation threshold.

9. The computer-implemented method of claim 3 wherein generating the distribution data object comprises:
generating, by the one or more processors, a predictive category data object for the entity based on the predictive identifier count data object, wherein the predictive category data object is indicative of: (i) one or more predictive categories corresponding to a category type, wherein a particular predictive category of the one or more predictive categories corresponds to a subset of a plurality of predictive identifiers associated with the entity, (ii) a category count corresponding to the particular predictive category, and (iii) an aggregate category count corresponding to each of the one or more predictive categories;
determining, by the one or more processors, a particular proportional relevance of the particular predictive category based on a comparison between the category count and the aggregate category count; and
generating, by the one or more processors, the distribution data object for the entity based on the particular proportional relevance.

10. The computer-implemented method of claim 9 wherein the category type is one of a plurality of category types, and wherein the distribution data object comprises a plurality of type-specific distributions corresponding to the plurality of category types.

11. The computer-implemented method of claim 1 further comprising:
receiving, by the one or more processors, an assigned classification for the entity;
generating, by the one or more processors, verification data for the entity based on a comparison between the assigned classification and the predictive classification; and
providing, by the one or more processors, an indication of the verification data for the entity.

12. The computer-implemented method of claim 11 wherein providing the indication of the verification data comprises providing, by the one or more processors, an alert indicative of a misclassification for the entity responsive to a determination that the assigned classification does not match the predictive classification.

13. A computing apparatus comprising one or more processors and memory including program code, the memory and the program code configured to, when executed by the one or more processors, cause the one or more processors to:
receive a predictive identifier count data object for an entity based on a historical interaction dataset associated with a plurality of entities, wherein the predictive identifier count data object is indicative of one or more identifier counts for one or more predictive identifiers associated with the entity;
generate, using a machine learning classification model, a predictive classification for the entity based on the one or more identifier counts; and
provide an indication of the predictive classification for the entity.

14. The computing apparatus of claim 13 wherein the one or more identifier counts for the one or more predictive identifiers comprise (a) a first identifier count for a first predictive identifier associated with the entity and (b) a second identifier count for a second predictive identifier associated with the entity.

15. The computing apparatus of claim 14 further configured to:
generate a distribution data object for the entity based on the first identifier count and the second identifier count, wherein the distribution data object is indicative of a proportional relevance of a predictive category associated with the entity, and
wherein generating the predictive classification is based on the distribution data object.

16. A computer program product comprising a non-transitory computer-readable storage medium, the non-transitory computer-readable storage medium including instructions that, when executed by one or more processors, cause the one or more processors to:
receive a predictive identifier count data object for an entity based on a historical interaction dataset associated with a plurality of entities, wherein the predictive identifier count data object is indicative of one or more identifier counts for one or more predictive identifiers associated with the entity;
generate, using a machine learning classification model, a predictive classification for the entity based on the one or more identifier counts; and
provide an indication of the predictive classification for the entity.

17. The computer program product of claim 16 wherein the one or more identifier counts for the one or more predictive identifiers comprise (a) a first identifier count for a first predictive identifier associated with the entity and (b) a second identifier count for a second predictive identifier associated with the entity.

18. The computer program product of claim 17 further configured to:
generate a distribution data object for the entity based on the first identifier count and the second identifier count, wherein the distribution data object is indicative of a proportional relevance of a predictive category associated with the entity, and
wherein generating the predictive classification is based on the distribution data object.

19. The computer program product of claim 18 further configured to:
receive a plurality of distribution data objects for the plurality of entities associated with an assigned classification;
generate an assigned classification distribution data object for the assigned classification based on the plurality of distribution data objects;
generate an investigative output for the entity based on a comparison between the distribution data object for the entity and the assigned classification data object; and
generate an indication of the investigative output for the entity.

20. The computer program product of claim 19 wherein the investigative output is based on a deviation threshold associated with the assigned classification.
